(19) United States
(12) Patent Application Publication
(10) Pub. No.: US 2014/0222435 A1
(43) Pub. Date: Aug. 7, 2014

(54) NAVIGATION SYSTEM WITH USER DEPENDENT LANGUAGE MECHANISM AND METHOD OF OPERATION THEREOF

(71) Applicant: TELENAV, INC., Sunnyvale, CA (US)

(72) Inventors: Weiying Li, Cupertino, CA (US); Aliasgar Mumtaz Husain, Milpitas, CA (US); Rajeev Agarwal, Fremont, CA (US)

(73) Assignee: TELENAV, INC., Sunnyvale, CA (US)

(21) Appl. No.: 13/757,524

(22) Filed: Feb. 1, 2013

(51) Int. Cl. G10L 21/00

(52) U.S. Cl. CPC G10L 21/00
USPC 704/275

(57) ABSTRACT

A method of operation of a navigation system includes: providing a history list including a request having a tag; assigning a probability to the request based on the tag to create a speaker dependent model; providing a returned result generated from the speaker dependent model; and updating the request and the tag of the history list based on a user's confirmation of the returned result for displaying on a device.

### TECHNICAL FIELD

The present invention relates generally to a navigation system, and more particularly to a system for mobile users.

### BACKGROUND ART

Modern portable consumer and industrial electronics, especially client devices such as navigation systems, cellular phones, portable digital assistants, and combination devices, are providing increasing levels of functionality to support modern life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use user information to provide navigation services such as a global positioning system (GPS) for a car or on a mobile device such as a cell phone, portable navigation device (PND) or a personal digital assistant (PDA).

Navigation systems and location-enabled systems have been incorporated in automobiles, notebooks, handheld devices, and other portable products. Today, these systems struggle to provide accurate usable information, customer service, or products in an increasingly competitive and crowded market place.

Thus, a need remains for a navigation system able to provide accurate, important, germane, and useful information to users. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: providing a history list including a request having a tag; assigning a probability to the request based on the tag to create a speaker dependent model; providing a returned result generated from the speaker dependent model; and updating the request and the tag of the history list based on a user's confirmation of the returned result for displaying on a device.

The present invention provides a navigation system, including: a history module for providing a history list including a request having a tag; a language module, coupled to the history module, for assigning a probability to the request based on the tag to create a speaker dependent model; a return results module, coupled to the language module, for providing a returned result generated from the speaker dependent model; and a management module, coupled to the history module, for updating the request and the tag of the history list based on a user's confirmation of the returned result for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a functional block diagram of a navigation system in an embodiment of the present invention.

FIG. 2 is an example of a display interface of the first device of FIG. 1.

FIG. 3 is an exemplary block diagram of the navigation system.

FIG. 4 is a control flow of the navigation system.

FIG. 5 is a detailed depiction of the history module of FIG. 4.

FIG. 6 is a detailed depiction of the management module of FIG. 5.

FIG. 7 is a detailed depiction of the language module of FIG. 4.

FIG. 8 is a flow chart of a method of operation of the navigation system of FIG. 1 in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a mobile navigation device.

In an alternative embodiment, navigation information is presented by longitude and latitude related information. In a further embodiment of the present invention, the navigation information also includes a velocity element including a speed component and a heading component.

The term “relevant information” referred to herein comprises the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof of the present invention in accordance with the context in which the term is used. For example, the software can be machine code, firmware, embedded code, and application software. Also for example, the hardware can be circuitry, processor, computer, integrated circuit, integrated circuit cores, a sensor, a micro-electro-mechanical system (MEMS), passive devices, or a combination thereof.

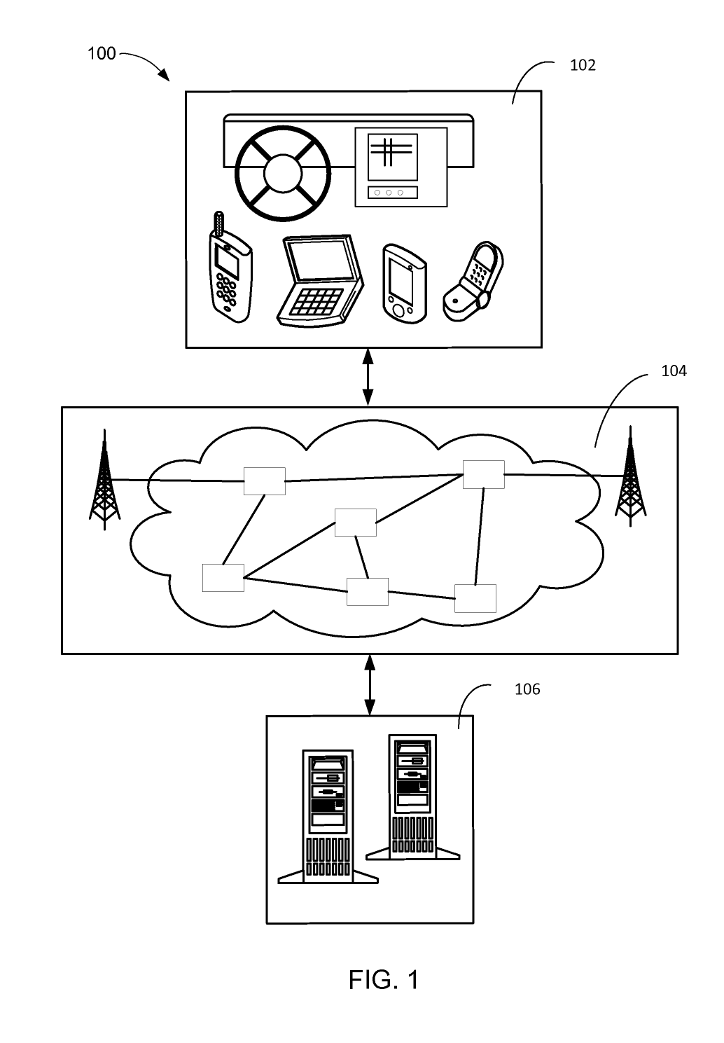

Referring now to FIG. 1, therein is shown a functional block diagram of a navigation system 100 in an embodiment of the present invention. The navigation system 100 includes a first device 102, such as a client or a server, connected to a second device 106, such as a client or server, with a communication path 104, such as a wireless or wired network.

For example, the first device 102 can be of any of a variety of mobile devices and can include global positioning satellite capability, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106. Coupling is defined as a physical connection.

For illustrative purposes, the navigation system 100 is described with the first device 102 as a mobile computing device, although it is understood that the first device 102 can be different types of computing devices. For example, the first device 102 can also be a non-mobile computing device, such as a server, a server farm, or a desktop computer.

The second device 106 can be any of a variety of centralized or decentralized computing devices. For example, the second device 106 can be a computer, grid-computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple IPhone™, Palm Centro™, or Moto Q Global™.

For illustrative purposes, the navigation system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the navigation system 100 is shown with the second device 106 and the first device 102 as endpoints of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

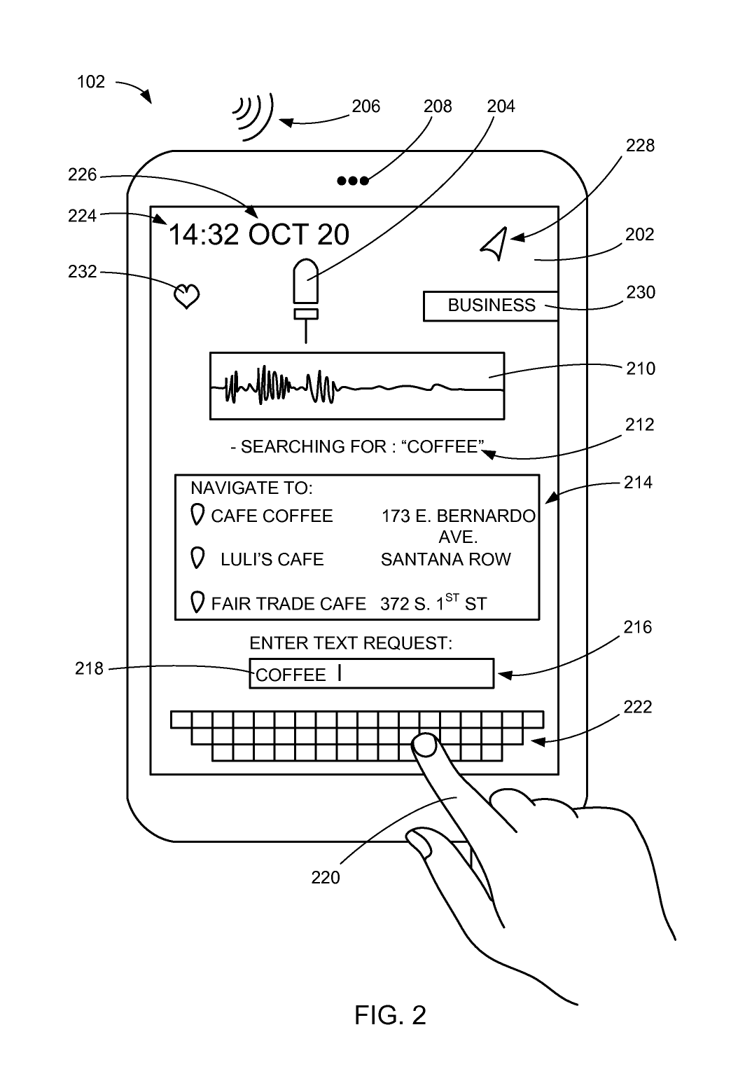

Referring now to FIG. 2, therein is shown an example of a display interface of the first device 102 of FIG. 1. The first device 102 can include a display 202 that can be an electronic hardware unit that presents information in a visual, audio, or tactile form. Examples of the display 202 can be a display device, a projector, a video screen, or a combination thereof. The display 202 can depict a voice input icon 204 indicating the first device 102 is expecting a verbal request 206 to be sensed by a microphone 208 coupled to the first device 102.

The display 202 can include a visual depiction 210 of the verbal request 206 sensed by the microphone 208. The display 202 can further include a proposed verbal request 212. The proposed verbal request 212 can be indicated or prefaced by template language that will indicate that the first device 102 is performing an action in accordance with the verbal request 206. For example, the proposed verbal request 212 can be indicated by the words “Searching for:” The display 202 can also include returned results 214 that result from the first device 102 acting on the verbal request 206 described in detail below.

The first device 102 can further include a text entry field 216 for entering a text request 218 by a user 220. The text request 218 can be entered with a key pad 222 such as a numeric key pad or a QWERTY keyboard. The returned results 214 can also result from the text request 218 described in detail below.

The first device 102 can display a time 224 on the display 202 along with a date 226 and a location 228. The time 224, the date 226, and the location 228 can be used to tag the proposed verbal request 212 as described in detail below.

For illustrative purposes, the navigation system 100 depicts an indicator for the location 228 as an arrow, which appears to be provide some directional information or compass like information for the magnetic north, however, the depiction is for convenience. The arrow illustration is to allow for the navigation system 100 to recognize its current location before the directionality of the illustration can be determined on the display 202.

The display 202 can further include a setting 230. The setting 230 can be changed by the user 220. The display 202 can also include a favorite's icon 232. The favorite's icon 232 can be an indicator chosen by the user 220 to indicate that the proposed verbal request 212 should be specially tagged as described in detail below.

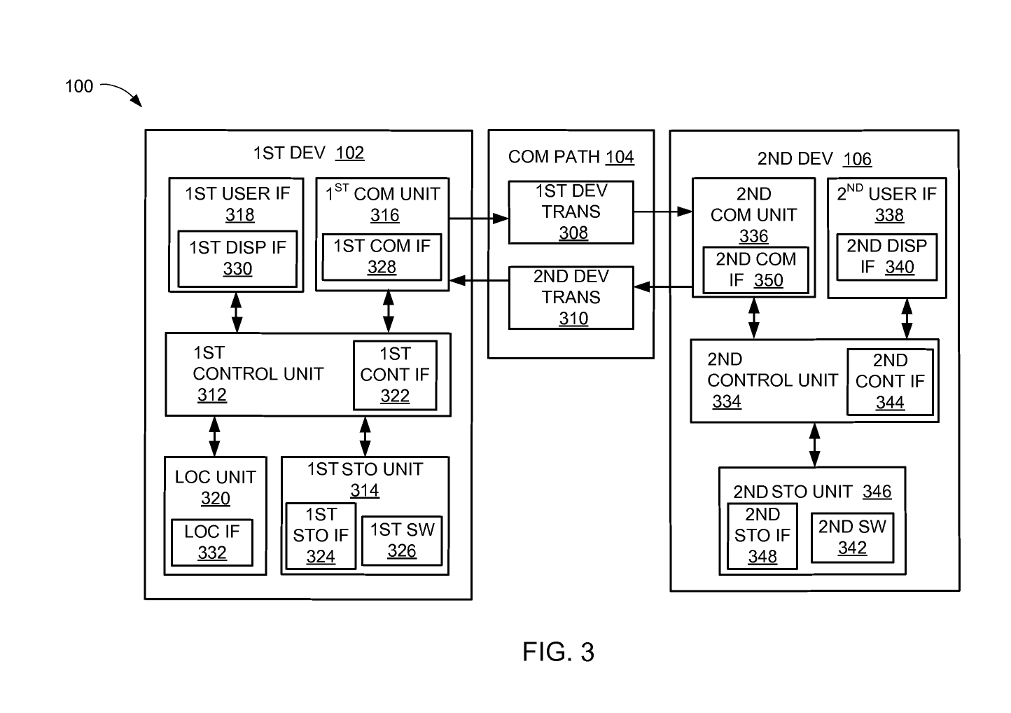

Referring now to FIG. 3, therein is shown an exemplary block diagram of the navigation system 100. The navigation system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the navigation system 100 is shown with the first device 102 as a client device, although it is understood that the navigation system 100 can have the first device 102 as a different type of device. For example, the first device 102 can be a server.

Also for illustrative purposes, the navigation system 100 is shown with the second device 106 as a server, although it is understood that the navigation system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 312, a first storage unit 314, a first communication unit 316, a first user interface 318, and a location unit 320. The first control unit 312 can include a first controller interface 322. The first control unit 312 can execute a first software 326 to provide the intelligence of the navigation system 100. The first control unit 312 can be implemented in a number of different manners. For example, the first control unit 312 can be a processor, an embedded processor, a microprocessor, hardware control logic, a hardware finite state machine (FSM), a digital signal processor (DSP), or a combination thereof. The first controller interface 322 can be used for communication between the first control unit 312 and other functional units in the first device 102. The first controller interface 322 can also be used for communication that is external to the first device 102.

The first controller interface 322 can receive information from the other functional units or from external sources, or can transmit information to the other functional units or to external destinations. The external sources and the external destinations refer to sources and destinations external to or physically separate from the first device 102.

The first controller interface 322 can be implemented in different ways. The first controller interface 322 can include different implementations depending on which functional units or external units are being interfaced with the first controller interface 322. For example, the first controller interface 322 can be implemented with a pressure sensor, an inertial sensor, a microelectromechanical system (MEMS), optical circuitry, waveguides, wireless circuitry, wireline circuitry, or a combination thereof.

The location unit 320 can generate location information, current heading, and current speed of the first device 102, as examples. The location unit 320 can be implemented in many ways. For example, the location unit 320 can function as at least a part of a global positioning system (GPS), an inertial navigation system, a cellular-tower location system, a pressure location system, or any combination thereof.

The location unit 320 can include a location interface 332. The location interface 332 can be used for communication between the location unit 320 and other functional units in the first device 102. The location interface 332 can also be used for communication that is external to the first device 102.

The location interface 332 can receive information from the other functional units or from external sources, or can transmit information to the other functional units or to external destinations. The external sources and the external destinations refer to sources and destinations external to or physically separate from the first device 102.

The location interface 332 can include different implementations depending on which functional units or external units are being interfaced with the location unit 320. The location interface 332 can be implemented with technologies and techniques similar to the implementation of the first controller interface 322.

The first storage unit 314 can store the first software 326. The first storage unit 314 can also store the relevant information, such as advertisements, points of interest (POI), navigation routing entries, or any combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between the location unit 320 and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to or physically separate from the first device 102.

The first storage interface 324 can include different implementations depending on which functional units or external units are being interfaced with the first storage unit 314. The first storage interface 324 can be implemented with technologies and techniques similar to the implementation of the first controller interface 322.

The first communication unit 316 can enable external communication to and from the first device 102. For example, the first communication unit 316 can permit the first device 102 to communicate with the second device 106, an attachment, such as a peripheral device or a computer desktop, and the communication path 104.

The first communication unit 316 can also function as a communication hub allowing the first device 102 to function as part of the communication path 104 and not limited to be an endpoint or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first controller interface 322.

The first user interface 318 allows a user (not shown) to interface and interact with the first device 102. The first user interface 318 can include an input device and an output device. Examples of the input device of the first user interface 318 can include the key pad 222 of FIG. 2, the microphone 208 of FIG. 2, a touchpad, soft-keys, a keyboard, a microphone, or any combination thereof to provide data and communication inputs.

The first user interface 318 can include a first display interface 330. The first display interface 330 can include the display 202 of FIG. 2, a projector, a video screen, a speaker, or any combination thereof.

The first control unit 312 can operate the first user interface 318 to display information generated by the navigation system 100. The first control unit 312 can also execute the first software 326 for the other functions of the navigation system 100, including receiving location information from the location unit 320. The first control unit 312 can further execute the first software 326 for interaction with the communication path 104 via the first communication unit 316.

The second device 106 can be optimized for implementing the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the navigation system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the navigation system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to or physically separate from the second device 106.

The second controller interface 344 can be implemented in different ways depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the relevant information, such as advertisements, points of interest (POI), navigation routing entries, or any combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the navigation system 100 is shown with the second storage unit 346 as a single hierarchy storage system, although it is understood that the navigation system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between the location unit 320 and other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to or physically separate from the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an endpoint or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The navigation system 100 can be executed by the first control unit 312, the second control unit 334, or a combination thereof.

For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. In addition, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the navigation system 100 is described by operation of the first device 102 and the second device 106. It is understood that the first device 102 and the second device 106 can operate any of the modules and functions of the navigation system 100. For example, the first device 102 is described to operate the location unit 320, although it is understood that the second device 106 can also operate the location unit 320.

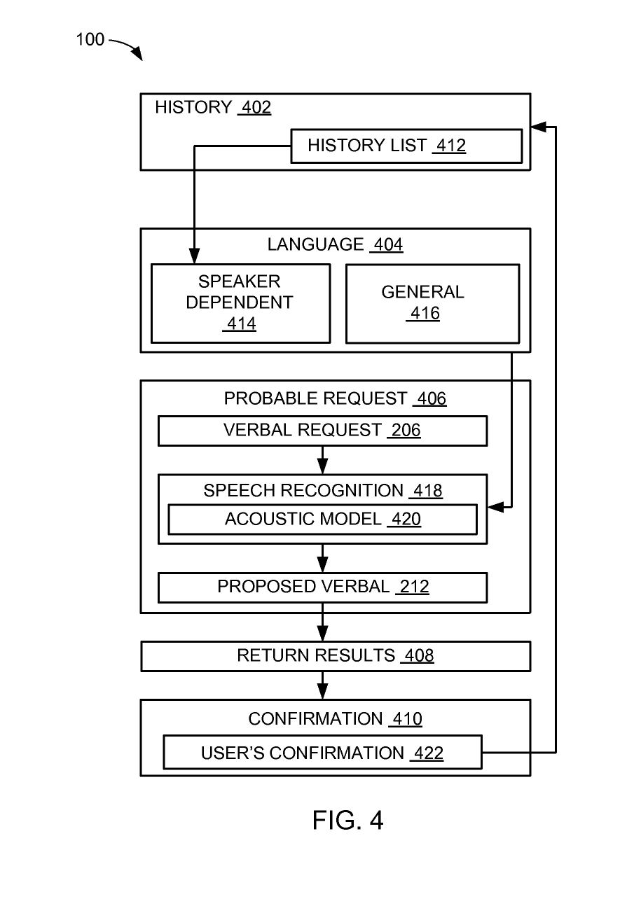

Referring now to FIG. 4, therein is shown a control flow of the navigation system 100. The navigation system 100 can include a history module 402. The history module 402 can be coupled to communicate with a language module 404. The language module 404 can be coupled to communicate to a probable request module 406. The probable request module 406 can be coupled to communicate to a return results module 408.

The return results module 408 can be coupled to communicate to a confirmation module 410. The confirmation module 410 can be coupled to feed back into the history module 402.

The history module 402 can include a history list 412 for the user 220 of FIG. 2 that is communicated to the language module 404. The language module 404 can include a speaker dependent model 414. The speaker dependent model 414 is a language model for automatic speech recognition that is unique to the user 220. The speaker dependent model 414 reads the history list 412 of the history module 402 and determines the likelihood that the user 220 will initiate the verbal request 206 contained within the history list 412, as described in detail below.

The language module 404 further includes a general model 416. The general model 416 is a language model for automatic speech recognition that is not unique to the user 220 but is general to the language or languages for any user. The general model 416 and the speaker dependent model 414 are provided to the probable request module 406.

The probable request module 406 can include the verbal request 206 as an input from the microphone 208 of FIG. 2. The probable request module 406 translates sounds of the verbal request 206 into the text of the proposed verbal request 212 using a speech recognition module 418. The verbal request 206 is input into the speech recognition module 418 along with the speaker dependent model 414, the general model 416, and an acoustic model 420. The speech recognition module 418 can utilize the speaker dependent model 414, the general model 416, and the acoustic model 420 to convert the verbal request 206 to the proposed verbal request 212 utilizing, for example: the Hidden Markov model, Dynamic Time Warping, Neural Networks Method, or a combination thereof.

The proposed verbal request 212 can be input into or read from the return results module 408. The return results module 408 can search for the proposed verbal request 212 utilizing a search engine such as Google™, Bing™, or other search engines to return the returned results 214 of FIG. 2.

The returned results 214 can be displayed on the display 202 of FIG. 2 and read by the confirmation module 410. When the user 220 selects one of the returned results 214, the confirmation module 410 recognizes a user's confirmation 422. When the user's confirmation 422 is recognized, the confirmation module 410 notifies the history module 402 that the proposed verbal request 212 should be incorporated in the history list 412 as described in detail below. The navigation system 100 can start with a default list for the history list 412 and the history list 412 can be updated, as described above as an example.

The history module 402 can operate on either the first device 102 of FIG. 1 or the second device 106 of FIG. 1. The history list 412 of the history module 402 can reside in the second storage unit 346 of FIG. 3 of the second device 106 or the first storage unit 314 of FIG. 3 of the first device 102.

The language module 404 can operate on the first control unit 312 of FIG. 3 of the first device 102 or on the second control unit 334 of FIG. 3 of the second device 106. The history list 412 can be read by or pushed to the speaker dependent model 414 through the communication path 104 of FIG. 1 from the history module 402 to the language module 404.

The general model 416 can reside in the first storage unit 314 or the second storage unit 346 of the first device 102 or the second device 106, respectively. The language module 404 can read the history list 412 through the first controller interface 322 of FIG. 3 or the second controller interface 344 of FIG. 3 of the first control unit 312 or the second control unit 334 respectively for building the speaker dependent model 414 on the first control unit 312 or the second control unit 334.

The probable request module 406 can operate on either the first control unit 312 of the first device 102 or the second control unit 334 of the second device 106. The verbal request 206 can be pushed from the microphone 208 of the first user interface 318 of FIG. 3 to the first control unit 312 or the second control unit 334 depending on where the probable request module 406 is operating.

The speech recognition module 418 of the probable request module 406 can operate on either the first control unit 312 or the second control unit 334 along with the probable request module 406 or separate from the probable request module 406. The acoustic model 420 can be stored in the first storage unit 314 or the second storage unit 346 and pushed to the speech recognition module 418 through the second storage interface 348 of FIG. 3 or the first storage interface 324 of FIG. 3.

The proposed verbal request 212 can be output from the speech recognition module 418 of the probable request module 406 through the first controller interface 322 or the second controller interface 344 depending on where the speech recognition module 418 is operating. Further, the proposed verbal request 212 can be output and displayed on the display 202 of the first user interface 318.

The return results module 408 can operate on either the first control unit 312 of the first device 102 or the second control unit 334 of the second device 106. The returned results 214 can be pushed to, and displayed on, the display 202 of the first display interface 330 of FIG. 3 of the first user interface 318 through the communication path 104.

The confirmation module 410 can be operated on the first control unit 312 or the second control unit 334 and detect the user's confirmation 422 from the first user interface 318. When the user's confirmation 422 is detected by the confirmation module 410 the proposed verbal request 212 can be incorporated into the history list 412 residing on the first storage unit 314 or the second storage unit 346.

The verbal request 206 is physically transformed from the microphone 208 and into the visual depiction 210 on the display 202. The verbal request 206 is also physically transformed from physical particles into the visual textual depiction of the proposed verbal request 212 on the display 202. The proposed verbal request 212 results in the returned results 214 resulting in movement of the user 220 during the user's confirmation 422. The user's confirmation 422 results in changes to the history list 412, which further modify the transformation of the verbal request 206 into the proposed verbal request 212. The display of the returned results 214 also results in changes to the location 228 of FIG. 2 of the first device 102 as the user 220 relocates the first device 102 to one of the returned results 214.

The modules discussed above and below can be implemented in hardware. For example, the modules can be implemented as hardware acceleration implementations in the first control unit 312, the second control unit 334, or a combination thereof. The modules can also be implemented as hardware implementations in the first device 102, the second device 106, or a combination thereof outside of the first control unit 312 or the second control unit 334. The history module 402, the language module 404, the probable request module 406, the return results module 408, and confirmation module 410 can be implement as hardware (not shown) within the first control unit 312, the second control unit 334, or special hardware (not shown) in the first device 102 or the second device 106.

It has been discovered that utilizing the history list 412 incorporating the user's confirmation 422 of the returned results 214 to create the speaker dependent model 414 increases the recognition performance for the user 220 of the first device 102. It has further been discovered that utilizing the speaker dependent model 414 in conjunction with the general model 416 of the language module 404 within the probable request module 406 greatly improves the accuracy of the return results module 408 to return the returned results 214 that will be confirmed by the user 220 in the confirmation module 410.

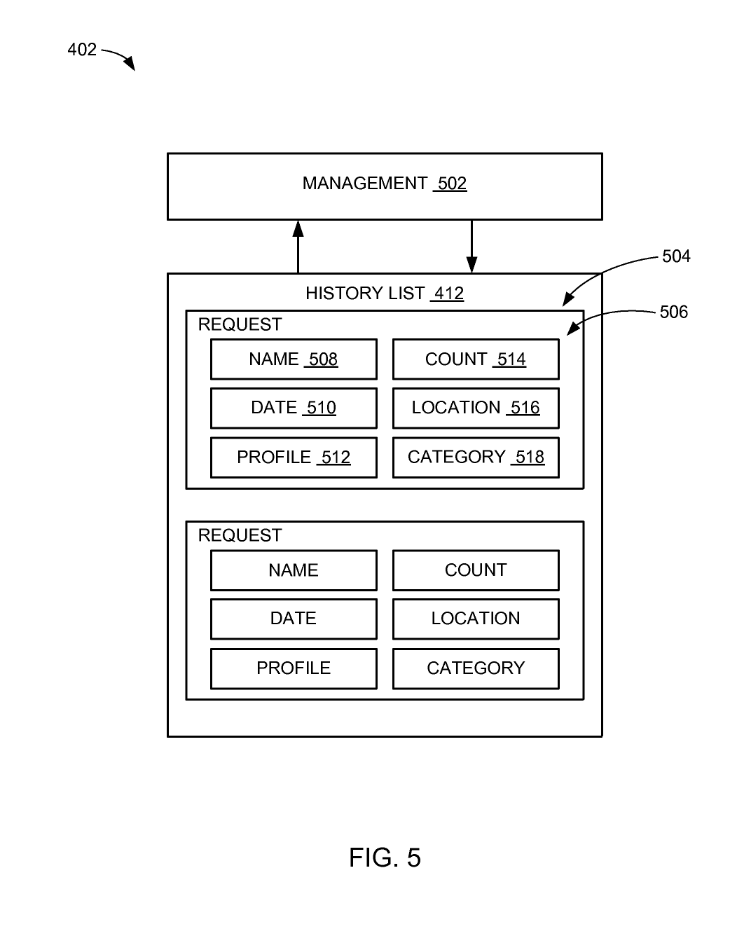

Referring now to FIG. 5, therein is shown a detailed depiction of the history module 402 of FIG. 4. The history module 402 is shown having the history list 412 coupled to a management module 502. The management module 502 can read or search the history list 412, described in detail below, to maintain the history list 412 up-to-date and relevant for the user 220 of FIG. 2.

The history list 412 can include requests 504. The requests 504 can be the proposed verbal request 212 of FIG. 2, the text request 218 of FIG. 2, or other sources such as, internet searches or favorites as described in detail below.

The requests 504 can include tags 506. The tags 506 can include a nametag 508, a date tag 510, a profile tag 512, a count tag 514, a location tag 516, and a category tag 518. The management module 502 can update the tags 506 of the requests 504, add requests 504, or delete requests 504 as described in detail below.

The nametag 508 of the requests 504 can be a string of characters that contains the name of the requests 504 made by the user 220 as described in detail below. For example, the name could be “coffee”, “Holiday Inn™”, “333 El Camino Real”, or other character strings.

The date tag 510 of the requests 504 can be a time stamp for the last time the requests 504 were made by the user 220 as described in detail below. For example, the date tag 510 could include “Dec. 13, 2012”, “17:34 Oct. 21, 2012”, or a combination thereof.

The profile tag 512 of the requests 504 can include a string of characters indicating a category of the user 220 at the time the requests 504 are made as described in detail below. As an example, the profile tag 512 can include “professional” or “family”.

The count tag 514 of the requests 504 can be a running tally of one of the requests 504 made by the user 220 as described in detail below. Each time one of the requests 504 is made by the user the count tag 514 can be incremented to track the aggregate usage of the requests 504.

The location tag 516 of the requests 504 can include a character string containing location identification at the time of the verbal request 206 of FIG. 2 as described in detail below. For example, the location tag 516 can include city and state such as “NY, N.Y.” or “San Francisco, Calif.”. As another example, the location tag 516 can include latitude and longitude values such as “34° 17′ N, 118° 28′ W” or “33° 33′ N, 117° 47′ W”. As another example, the location tag 516 can include a general geographic region such as “Disneyland™” or “Rocky Mountain National Park”.

The category tag 518 of the requests 504 can include a character string indicating a classification of the requests 504 made by the user 220 as described in detail below. As an example, the category tag 518 can be “Sports”, “Football”, or “dining”.

The history module 402 including the management module 502 can be operated on the first control unit 312 of FIG. 3 or the second control unit 334 of FIG. 3. The history list 412 can reside on the first storage unit 314 of FIG. 3 or the second storage unit 346 of FIG. 3. The requests 504 can be stored on the first storage unit 314, the second storage unit 346, or a combination thereof.

The nametag 508 can be recorded from the proposed verbal request 212, the text request 218, or other sources and stored on the first storage unit 314 or the second storage unit 346. The date tag 510 can be incorporated from the date 226 of FIG. 2, the time 224 of FIG. 2, of the first device 102 of FIG. 1 or the second device 106 of FIG. 1. The date 226 and the time 224 can be recorded as the date tag 510 when the user 220 makes the requests 504 that are tagged.

The profile tag 512 can be recorded and stored in the first storage unit 314 of the first device 102 or the second storage unit 346 of the second device 106. The profile tag 512 can be copied from a classification of the proposed verbal request 212 or the returned results 214 of FIG. 2 stored in the first storage unit 314 of the first device 102 or the second storage unit 346 of the second device 106.

The count tag 514 can be stored on the first storage unit 314 of the first device 102 or the second storage unit 346 of the second device 106. The count tag 514 can be updated and incremented as described in detail below.

The location tag 516 can be stored on the first storage unit 314 of the first device 102 or the second storage unit 346 of the second device 106. The location tag 516 can be recorded from the location unit 320 of FIG. 3 of the first device 102 when the user 220 made the requests 504.

The category tag 518 can be stored on the first storage unit 314 of the first device 102 or the second storage unit 346 of the second device 106. The category tag 518 can be copied from a classification of the proposed verbal request 212 or the returned results 214 stored in the first storage unit 314 or the second storage unit 346.

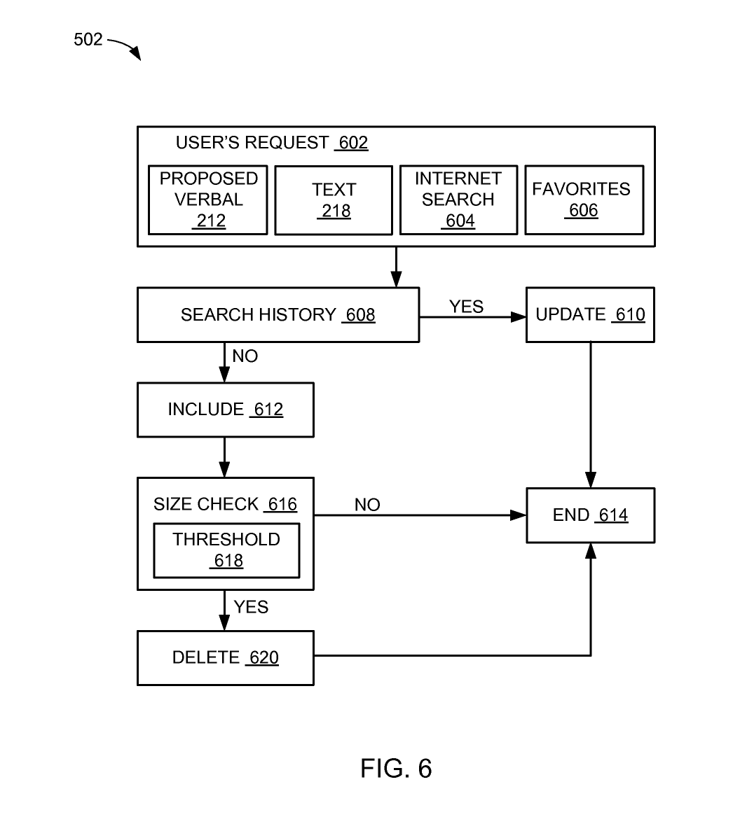

Referring now to FIG. 6 therein is shown a detailed depiction of the management module 502 of FIG. 5. The management module 502 is shown having a user's request 602. The user's request 602 can be one of the requests 504 of FIG. 5 and include the tags 506 of FIG. 5. The user's request 602 can include the proposed verbal request 212 for incorporation into the history list 412 of FIG. 4 after the user's confirmation 422 of FIG. 4 of the returned results 214 of FIG. 2.

The user's request 602 can also include the text request 218. The text request 218 can be included when the user 220 confirms one of the returned results 214 of the first device 102 of FIG. 1 with the user's confirmation 422.

The user's request 602 can also include an internet search 604. The internet search 604 can be a search the user 220 made and that is traceable to the user 220. As an example the internet search 604 can be traceable to the user when the user 220 makes the internet search 604 when logged in to an account (not shown) personal to the user 220, or when the user 220 makes the internet search 604 using the first device 102 that is personal to the user 220.

The user's request 602 can also include favorites 606. The favorites 606 can be determined by the user 220 if the user links one of the requests 504 to one of the favorites 606. The user 220 can link one of the favorites 606 to one of the requests 504, for example, by clicking the favorite's icon 232 of FIG. 2 on the display 202 of FIG. 2 or over the internet. The favorites 606 can be utilized by the user 220 by speaking, for example, “favorite one” or “favorite two”.

The user's request 602 can be pushed to or read from a search history module 608. The search history module 608 can search the history list 412 and determine whether the user's request 602 is one of the requests 504 contained in the history list 412. When the search history module 608 finds that the user's request 602 is one of the requests 504 in the history list 412, the search history module 608 can push the user's request 602 to an update module 610. When the search history module 608 finds that the user's request 602 is not one of the requests 504 in the history list 412, the search history module 608 can push the user's request 602 to an include module 612.

The update module 610 can increment the count tag 514 of FIG. 5 of the user's request 602 by a single count. The update module 610 can also update the location tag 516 of FIG. 5 with the location 228 of FIG. 2 that the user 220 was in when the user's request 602 was made. The update module 610 can also update the date tag 510 of FIG. 5 with the date 226 of FIG. 2 and the time 224 of FIG. 2 when the user 220 made the user's request 602.

When the count tag 514, the location tag 516, and the date tag 510 have been updated by the update module 610, the management module 502 can invoke an end management module 614. The end management module 614 is the state of the management module 502 when the history list 412 is up-to-date and no more actions need to be taken to maintain or update the history list 412.

The include module 612 can be invoked when the search history module 608 does not find the user's request 602 within the history list 412. When the include module 612 is invoked the include module 612 can update the tags 506 of the user's request 602. The nametag 508 of FIG. 5 can be updated by copying the proposed verbal request 212, the text request 218, the internet search 604, or the favorites 606 to the nametag 508. The date tag 510 can be updated by copying the date 226 and the time 224 onto the date tag 510.

The profile tag 512 can be updated by copying the setting 230 of FIG. 2 onto the profile tag 512. The count tag 514 can be set to one or the first instance. The location tag 516 can be updated by copying the location 228 into the location tag 516. The category tag 518 can be set by matching the nametag 508 with synonyms contained in a category chart (not shown) and copying a corresponding category into the category tag 518.

When the include module 612 has completed updating the tags 506 of the user's request 602 a size check module 616 can be invoked. The size check module 616 can include a threshold 618. The size check module 616 can count the number of the requests 504 in the history list 412 and compare the number of the requests 504 to the threshold 618. When the number of the requests 504 is above the threshold 618 the size check module 616 can return a “yes” and invoke a delete module 620. When the number of the requests 504 is the same or below the threshold 618, the size check module 616 can return a “no” and invoke the end management module 614.

When the delete module 620 is invoked, the delete module 620 will evaluate the requests 504 and determine the tags 506 with the oldest date tag 510. When the requests 504 with the oldest date tag 510 have been identified the delete module 620 can delete the oldest one of the requests 504. An alternative method can be to find the oldest requests 504 falling within a window of each other and delete one of the requests 504 falling within the window with value for the lowest count tag 514. The management module 502 in this way can ensure the history list 412 is up-to-date and current in light of the activity of the user 220. When the delete module 620 has deleted one of the requests 504, the delete module 620 can invoke the end management module 614.

The management module 502 can be operated on the first control unit 312 of FIG. 3 or the second control unit 334 of FIG. 3 of the first device 102 or the second device 106 of FIG. 1, respectively. The user's request 602 can be stored on the first storage unit 314 of FIG. 3 or the second storage unit 346 of FIG. 3.

The user's request 602 can be read from the first storage unit 314 or the second storage unit 346 through the first controller interface 322 of FIG. 3 or the second controller interface 344 of FIG. 3 depending on whether the management module 502 is operating on the first device 102 or the second device 106.

The tags 506 of the requests 504 can be stored in the first storage unit 314 or the second storage unit 346 as text and written or read from the first storage unit 314 or the second storage unit 346 with the first storage interface 324 of FIG. 3 or the second storage interface 348 of FIG. 3, respectively.

The internet search 604 can be detected by the first device 102 or the second device 106 over the communication path 104 of FIG. 1. The internet search 604 can be conducted by the user 220 on the first device 102 or the second device 106, or over the communication path 104.

The favorites 606 can be set by the user 220 through the key pad 222 of FIG. 2, the favorite's icon 232 on the display 202 of the first user interface 318 of FIG. 3, or from the second user interface 338 of FIG. 3. The favorites 606 can further be stored in the first storage unit 314 or the second storage unit 346.

The search history module 608 can be operated on the first control unit 312 of the first device 102 or the second control unit 334 of the second device 106. The search history module 608 can search the history list 412 contained on the first storage unit 314 or the second storage unit 346 through the first storage interface 324 or the second storage interface 348, respectively.

The update module 610 can operate on the first control unit 312 of the first device 102 or the second control unit 334 of the second device 106. The update module 610 can increment the count tag 514 stored in the first storage unit 314 or the second storage unit 346. The update module 610 can also update the location tag 516 stored in the first storage unit 314 of the first device 102 or the second storage unit 346 of the second device 106.

The location tag 516 can be updated by overwriting the value stored for the location tag 516 with the location 228 of the user 220 determined by the location unit 320 of FIG. 3 at the time the user's request 602 was made. The update module 610 can also update the date tag 510 in the first storage unit 314 of the first device 102 or the second storage unit 346 of the second device 106. The date tag 510 can be updated by overwriting the value for the date tag 510 in the first storage unit 314 or the second storage unit 346 with the date 226 and the time 224 that the user's request 602 was made.

The include module 612 can operate on the first control unit 312 of the first device 102 or the second control unit 334 of the second device 106. The include module 612 can update the tags 506 of the user's request 602 contained in the first storage unit 314 of the first device 102 or the second storage unit 346 of the second device 106.

The nametag 508 of FIG. 5 can be updated by copying the proposed verbal request 212, the text request 218, the internet search 604, or the favorites 606 to the nametag 508 and stored in the first storage unit 314 or the second storage unit 346. The date tag 510 can be updated by copying the date 226 and the time 224 onto the date tag 510 stored in the first storage unit 314 or the second storage unit 346.

The profile tag 512 can be updated by copying the setting 230 onto the profile tag 512 stored in the first storage unit 314 or the second storage unit 346. The count tag 514 can be given a value of “1” and stored in the first storage unit 314 or the second storage unit 346. The location tag 516 can be updated by copying the location 228 into the location tag 516 from the location unit 320. The category tag 518 can be set by matching the nametag 508 with synonyms contained in a category chart stored in the first storage unit 314 or the second storage unit 346 and copying a corresponding category into the category tag 518 stored in the first storage unit 314 or the second storage unit 346.

The size check module 616 can be operated on the first control unit 312 of the first device 102 or the second control unit 334 of the second device 106. The threshold 618 of the size check module 616 can be stored in the first storage unit 314 or the second storage unit 346 and changed by the user 220 through the first user interface 318 or the second user interface 338.

The size check module 616 can compare the number of the requests 504 in the history list 412 to the threshold 618 in the first control unit 312 or the second control unit 334. The delete module 620 can operate on the first control unit 312 of the first device 102 or the second storage unit 346 of the second device 106 to evaluate the requests 504 and determine the tags 506 with the oldest date tag 510 stored in the first storage unit 314 or the second storage unit 346. The delete module 620 can delete the oldest one of the requests 504 stored on the first storage unit 314 or the second storage unit 346 by communicating through the first controller interface 322 or the second controller interface 344 to delete one of the requests 504.

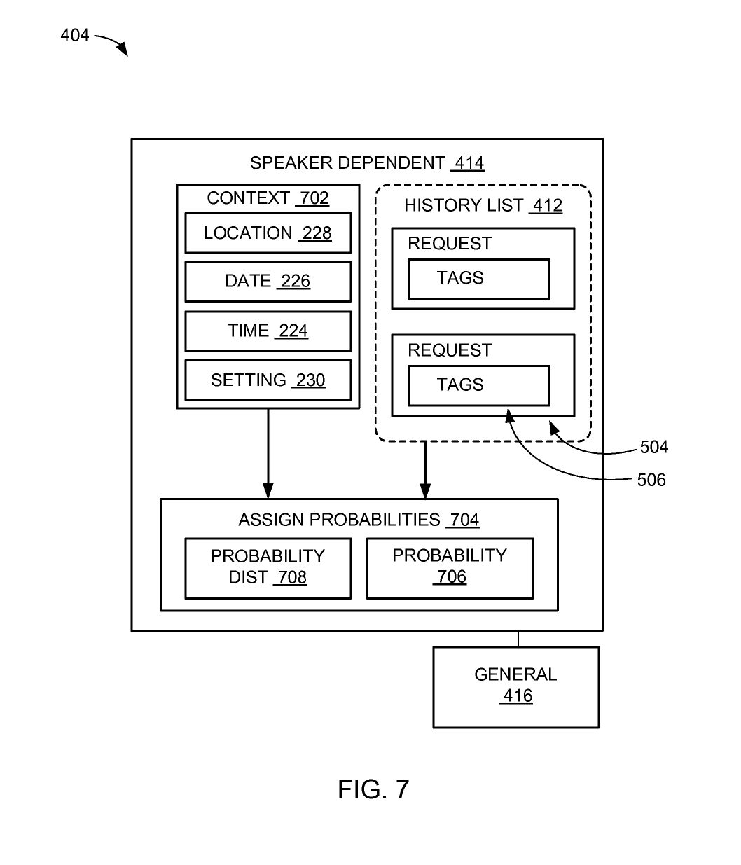

Referring now to FIG. 7 therein is shown a detailed depiction of the language module 404 of FIG. 4. The language module 404 is shown having both the speaker dependent model 414 and the general model 416. The language module 404 can provide both the speaker dependent model 414 and the general model 416 to the speech recognition module 418 of FIG. 4.

The speaker dependent model 414 can include the history list 412 with the requests 504. The speaker dependent model 414 can read the history list 412 from the history module 402 of FIG. 4 or can copy the history list 412 from the history module 402 into the speaker dependent model 414 in its entirety.

The speaker dependent model 414 can also include a context module 702. The context module 702 can read the location 228, the time 224, the date 226, and the setting 230 from the first device 102 of FIG. 1 or the second device 106 of FIG. 1.

The context module 702 can push the date 226, the time 224, the location 228, and the setting 230 to an assign probabilities module 704. The history list 412 with the requests 504 can also be pushed to the assign probabilities module 704. Alternatively, the assign probabilities module 704 can read the time 224, the date 226, the location 228, or the setting 230 from the context module 702 or can read the requests 504 from the history list 412.

The assign probabilities module 704 can assign a probability 706 to each one of the requests 504 by using a probability distribution 708. The probability distribution 708 can assign the probability 706 to the requests 504 by creating a stochastic model of the requests 504 incorporating the date 226, the time 224, the location 228, the setting 230, and the tags 506 as deterministic arguments. The assign probabilities module 704 can utilize various forms of the probability distribution 708 such as the Poisson distributions or the Chi-squared distribution.

The probability 706 assigned to each of the requests 504 can be the predicted likelihood that any one of the requests 504 will be made by the user 220 of FIG. 2 as the verbal request 206 of FIG. 2. The probability 706 of the speaker dependent model 414 is based on the history list 412 unique to the user 220 and can be utilized along with the general model 416 to increase effectiveness of the speech recognition module 418.

The language module 404 can be implemented by the first control unit 312 of FIG. 3 or the second control unit 334 of FIG. 3. The speaker dependent model 414 and the general model 416 can reside or be stored on the first storage unit 314 of FIG. 3 or the second storage unit 346 of FIG. 3. The language module 404 can provide both the speaker dependent model 414 and the general model 416 to the speech recognition module 418 through the first controller interface 322 of FIG. 3 or the second controller interface 344 of FIG. 3.

The history list 412 can reside on either the first storage unit 314 or the second storage unit 346. The history list 412 can be utilized by the speaker dependent model 414 by reading the first storage unit 314 or the second storage unit 346 through the first controller interface 322 or the second controller interface 344 depending on whether the speaker dependent model 414 is implemented on the first device 102 or the second device 106.

The first storage unit 314 or the second storage unit 346 storing the history list 412 can further store the requests 504, each of the requests 504 including the tags 506. The speaker dependent model 414 can also include a context module 702 implemented on the first control unit 312 or the second control unit 334. The context module 702 can read the location 228 from the location unit 320 of FIG. 3, the time 224 from the first device 102 or the second device 106, the date 226 from the first device 102 or the second device 106, and the setting 230 from the first device 102 or the second device 106.

The context module 702 can push the date 226, the time 224, the location 228, and the setting 230 through the first controller interface 322 or the second controller interface 344 to the assign probabilities module 704 implemented on the first control unit 312 or the second control unit 334. The history list 412 with the requests 504 can also be pushed through the first controller interface 322 or the second controller interface 344 to the assign probabilities module 704 implemented on the first control unit 312 or the second control unit 334.

The assign probabilities module 704 can assign a probability 706, computed on the first control unit 312 or the second control unit 334, to each one of the requests 504 stored in the first storage unit 314 or the second storage unit 346. The assign probabilities module 704 can utilize a probability distribution 708 with the first software 326 of FIG. 3 or the second software 342 of FIG. 3.

The probability 706 assigned to each of the requests 504 can be stored in the first storage unit 314 or the second storage unit 346. The probability 706 can predict a likelihood that any one of the requests 504 will be made by the user 220 as the verbal request 206 into the microphone 208 of FIG. 2 of the first user interface 318 of FIG. 3.

It has been discovered that utilizing the history list 412 updated by the management module 502 of FIG. 5 maintains an up-to-date record of the requests 504 of the user 220 of FIG. 2 and provides enhanced accuracy in returning the returned results 214 that are relevant to the user 220. It has been further discovered that utilizing the date 226, the location 228, the time 224, and the setting 230 in the assign probabilities module 704 increases the accuracy of applying the probability distribution 708 to the requests 504. It has been further discovered that the speaker dependent model 414 is greatly enhanced and able to match the verbal request 206 of the user 220 when the text request 218 of FIG. 2, the internet search 604 of FIG. 6, and the favorites 606 of FIG. 6 are incorporated into the history list 412.

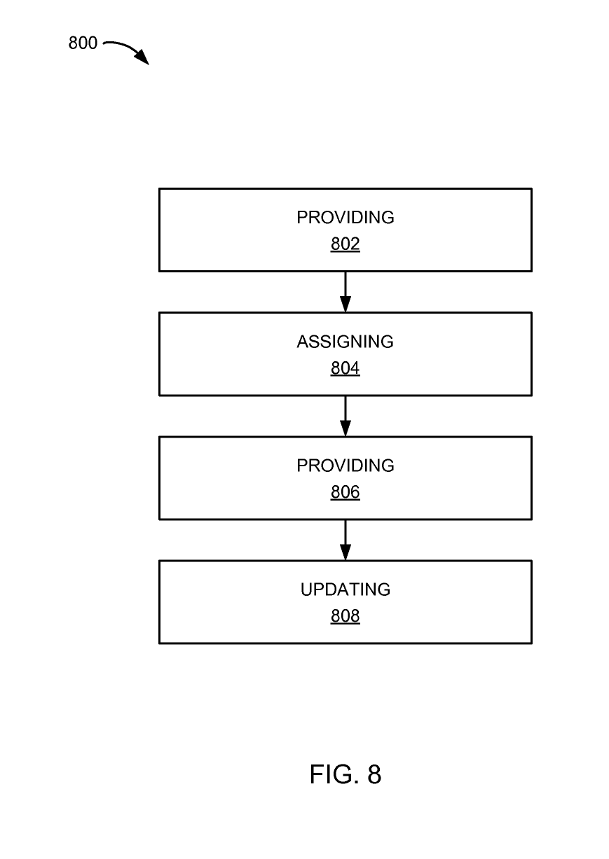

Referring now to FIG. 8, therein is shown a flow chart of a method 800 of operation of the navigation system 100 of FIG. 1 in a further embodiment of the present invention. The method 800 includes: providing a history list including a request having a tag in a block 802; assigning a probability to the request based on the tag to create a speaker dependent model in a block 804; providing a returned result generated from the speaker dependent model in a block 806; and updating the request and the tag of the history list based on a user's confirmation of the returned result for displaying on a device in a block 808.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
providing a history list including a request having a tag;
assigning a probability to the request based on the tag to create a speaker dependent model;
providing a returned result generated from the speaker dependent model; and
updating the request and the tag of the history list based on a user's confirmation of the returned result for displaying on a device.

2. The method as claimed in claim 1 wherein providing the returned result includes providing the returned result generated from a general model.

3. The method as claimed in claim 1 wherein providing the returned result includes providing the returned result by searching for a proposed verbal request in the speaker dependent model.

4. The method as claimed in claim 1 wherein updating the request and the tag of the history list includes adding a user's request confirmed by the user's confirmation.

5. The method as claimed in claim 1 wherein updating the request and the tag of the history list includes deleting the request when the history list is above a threshold.

6. A method of operation of a navigation system comprising:
providing a history list including a request having a tag;
assigning a probability to the request based on the tag, a date, a time, a setting, and location to create a speaker dependent model;
providing a returned result generated from the speaker dependent model; and
updating the request and the tag of the history list based on a user's confirmation of the returned result for displaying on a device.

7. The method as claimed in claim 6 wherein updating the request and the tag of the history list includes updating a date tag and a count tag.

8. The method as claimed in claim 6 wherein providing the history list including the request includes providing the history list having a proposed verbal request, a text request, an internet search, a favorite, or a combination thereof.

9. The method as claimed in claim 6 wherein providing the returned result includes providing the returned result generated by translating a verbal request into a proposed verbal request.

10. The method as claimed in claim 6 wherein updating the tag includes updating a profile tag based on the setting.

11. A navigation system comprising:
a history module for providing a history list including a request having a tag;
a language module, coupled to the history module, for assigning a probability to the request based on the tag to create a speaker dependent model;
a return results module, coupled to the language module, for providing a returned result generated from the speaker dependent model; and
a management module, coupled to the history module, for updating the request and the tag of the history list based on a user's confirmation of the returned result for displaying on a device.

12. The navigation system as claimed in claim 11 wherein the return results module is for providing the returned result generated from a general model.

13. The navigation system as claimed in claim 11 wherein the return results module is for providing the returned result by searching for a proposed verbal request in the speaker dependent model.

14. The navigation system as claimed in claim 11 wherein the management module is for adding a user's request confirmed by the user's confirmation.

15. The navigation system as claimed in claim 11 wherein the management module is for deleting the request when the history list is above a threshold.

16. The navigation system as claimed in claim 11 wherein the language module is for assigning the probability to the request based on the tag, a date, a time, a setting, and location to create the speaker dependent model.

17. The navigation system as claimed in claim 16 wherein the management module is for updating a date tag and a count tag.

18. The navigation system as claimed in claim 16 wherein the history module is for providing the history list having a proposed verbal request, a text request, an internet search, a favorite, or a combination thereof.

19. The navigation system as claimed in claim 16 wherein the return results module is for providing the returned result generated by translating a verbal request into a proposed verbal request.

20. The navigation system as claimed in claim 16 wherein the management module is for updating a profile tag based on the setting.
